(19) United States
(12) Patent Application Publication
(10) Pub. No.: US 2019/0002259 A1
(43) Pub. Date: Jan. 3, 2019

(54) Powered Crowbar

(71) Applicant: Timothy Nichols, Saint Marys, WV (US)

(72) Inventor: Timothy Nichols, Saint Marys, WV (US)

(21) Appl. No.: 16/010,856

(22) Filed: Jun. 18, 2018

Related U.S. Application Data
(60) Provisional application No. 62/527,998, filed on Jun. 30, 2017.

(51) Int. Cl. B66F 15/00; H02K 7/06

(52) U.S. Cl. CPC B66F 15/00; H02K 7/063

(57) ABSTRACT

A device for removing materials secured to surfaces. The powered crowbar includes a shaft having a first end and a second end, wherein the first end tapers to a flat chisel, such that the chisel is designed to fit within tight spaces. The second end includes a housing and grip, wherein the grip is designed to be held by a user. The housing has a motor, a power source operably connected to the motor, a control module operably connected to the motor, and an activation switch operably connected to the motor. The motor is designed to vibrate the shaft and chisel. In this way, the powered crowbar efficiently loosens and removes materials, such as a nailed board, secured to a surface.

### CROSS REFERENCE TO RELATED APPLICATIONS

This application claims the benefit of U.S. Provisional Application No. 62/527,998 filed on Jun. 30, 2017. The above identified patent application is herein incorporated by reference in its entirety to provide continuity of disclosure.

### BACKGROUND OF THE INVENTION

The present invention relates to powered crowbars. More specifically, the present invention provides a shaft having an end tapered to a flat chisel and a housing and grip disposed at the opposite end, wherein the housing comprises a motor, power source, control module and activation switch in communication with one another.

Traditionally, crowbars are utilized when a user is attempting to remove a secured material, such as a nailed wooden board, from a surface, such a framing joint or crate. Unfortunately, many individuals have difficulty prying the board off the crate, depending on how long the material has been nailed to the surface, as wood expands and contracts over extended periods of time. Additionally, the user may lack the strength necessary to remove the board despite using the leverage power of a crowbar. Often, this results in the crowbar slipping and potentially damaging the individual or others nearby. Further, some people will additionally use a hammer to provide a greater force on the handle of the crowbar, which can damage the crowbar or provide an additional injury to the user. Thus, an improved crowbar is desired to allow individuals to more easily remove secured materials from surfaces without requiring extensive force.

### SUMMARY OF THE INVENTION

In view of the foregoing disadvantages inherent in the known types of powered crowbar now present in the known art, the present invention provides a new powered crowbar wherein the same can be utilized for providing convenience for the user when attempting to efficiently remove a material from a surface.

It is therefore an object of the present invention to provide a new and improved powered crowbar that has all the advantages of the known art and none of the disadvantages. The present system comprises a shaft having a first end and a second end, wherein the first end tapers to a flat chisel, such that the chisel is configured to fit within tight spaces, and the second end comprises a housing and grip, wherein the grip is configured to be held by a user. The housing has a motor, a power source operably connected to the motor, a control module operably connected to the motor, and an activation switch operably connected to the motor, wherein the motor is configured to vibrate the shaft and chisel. In this way, the powered crowbar efficiently loosens and removes secured materials from a surface.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the powered crowbar.

FIG. 2 shows a perspective view of an embodiment of the components within the powered crowbar.

FIG. 3 shows a perspective view of an embodiment of the power source and charging station.

FIG. 4 shows a perspective view of an embodiment of the powered crowbar with an additional housing.

FIG. 5 shows a perspective view of an embodiment of the powered crowbar in use.

### DETAILED DESCRIPTION OF THE INVENTION

Reference is made herein to the attached drawings. Like reference numerals are used throughout the drawings to depict like or similar elements of the powered crowbar. The figures are intended for representative purposes only and should not be considered to be limiting in any respect.

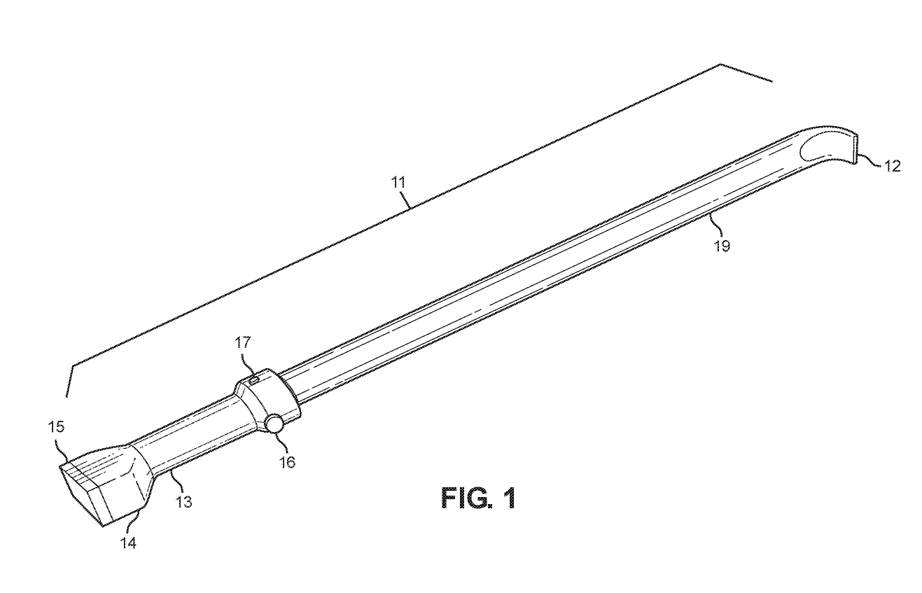

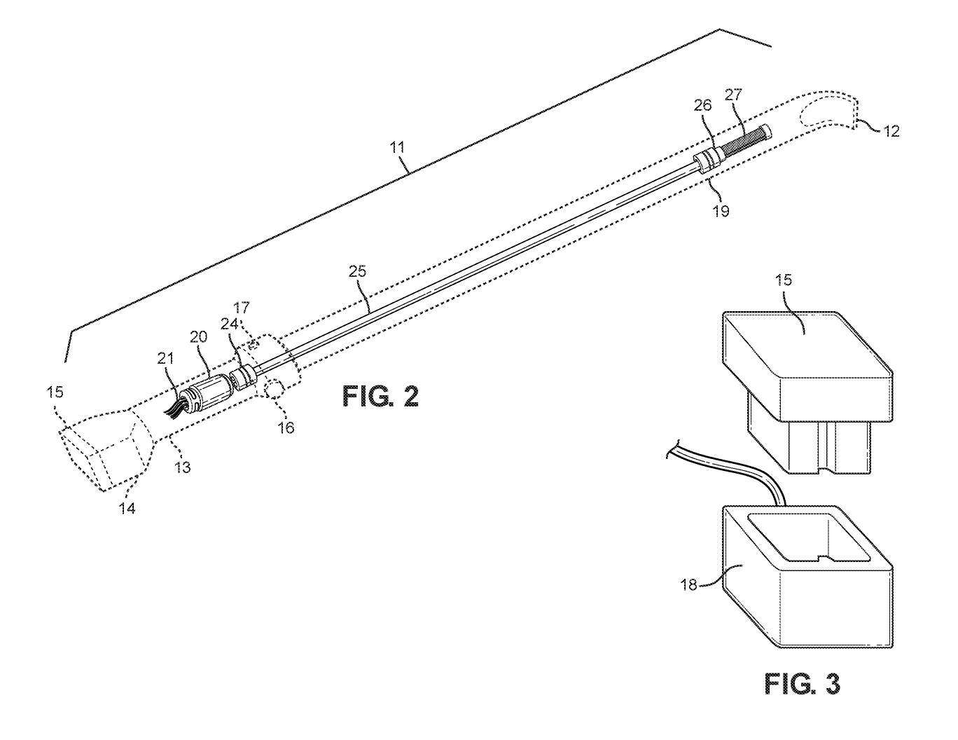

Referring now to FIG. 1 and FIG. 2 there are shown perspective views of the powered crowbar and the components within the powered crowbar, respectively. A powered crowbar 11 comprises a shaft 19 having a first end and a second end, wherein the first end comprises a flat chisel 12. The chisel 12 is tapered to an edge, such that the chisel 12 is configured to fit within tight spaces such as between a board and a wall. In the illustrated embodiment, the chisel 12 is curved, such that the edge of the chisel 12 can fit underneath the board, thereby providing greater leverage. The shaft 19 is sized such that a user can hold the shaft with two hands. In one embodiment, the shaft 19 is composed of steel, however in other embodiments the shaft 19 can be composed of any durable material. In another embodiment, the shaft 19 is flexible, such that the user can partially flex the shaft 19, thereby accommodating any additional pressure exerted on the powered crowbar 11.

The handle comprises a housing 14 and a grip 13. In the illustrated embodiment, the housing 14 tapers inwardly from opposing ends thereof to form the grip 13. In this way, the grip 13 prevents the user's hands from sliding off of the grip 13 due to vibration or force exerted on the shaft 19. The chisel 12 is disposed such that the edge is perpendicular to the palm of the user's hand. In this way, a greater amount of torque can be applied to the board with the user exerting less overall force, thereby easily allowing the user to remove the secured material from the surface.

The housing 14 has a motor 20 as well as a power source 15 operably connected to the motor 20. The motor 20 is operably connected to the power source 15, such that the power source 15 provides power to the motor 20. The motor 20 is configured to vibrate the powered crowbar 11 at a high frequency, thereby causing the shaft 19 and chisel 12 to vibrate. In this way, when the chisel 12 is applied to the board, the high frequency vibration aids in loosening any secured materials from a surface, such as nails from a board. In one embodiment, the grip 13 is composed of a non-conductive material that acts as a vibration damper and shock absorber, such as Sorbothane. In this way, a user can continue to hold the powered crowbar 11 at the grip 13 when the motor 20 is in operation without losing control of the powered crowbar 11. In another embodiment, the grip 13 is sized such that a user can grasp the shaft 19 with two hands on the grip 13.

Within the shaft 19, a drive shaft 25 is disposed, having a first end connected to the motor 20 and a second end connected to an unbalanced rotating shaft 27, having one side heavier than the other. The drive shaft 25 is configured to be flexible, such that it can aid in vibrating the shaft 19. Both ends of the drive shaft 25 are connected to the motor 20 and unbalanced rotating shaft 27 via a coupler 24, respectively, whereas the unbalanced rotating shaft 27 additionally has a pair of bearings 26 disposed on either end to provide further stability. The motor 20 is configured to power the unbalanced rotating shaft 27, wherein the vibrations provided by the unbalanced rotating shaft are configured to move the drive shaft 25 and thereby vibrate the powered crowbar 11.

A control module 16 and an activation switch 17 are operably connected to the motor 20 through a plurality of wires 21 disposed in the housing 14. In the illustrated embodiment, the wires 21 are configured to further comprise a strain gauge, such that the motor 20 is configured to shut off if put under more strain than the motor 20 can manage. In the illustrated embodiment, the wires 21 are configured to further comprise a strain gauge, such that the motor 20 is configured to shut off if put under more strain than the motor 20 can manage. In the shown embodiment, the wires 21 are disposed in the center of the shaft 19, such that they are disposed beneath the grip 13. In the shown embodiment, the wires 21 are disposed in the center of the shaft 19, such that they are disposed beneath the grip 13. The control module 16 and activation switch 17 are both disposed on a portion of the housing 14. In the illustrated embodiment, the power source 15 is disposed at a distal portion of the second end of the shaft 19, wherein the control module 16 and the activation switch 17 are disposed further up the shaft 19, such that the grip 13 is disposed therebetween. However, in other embodiments, the control module 16 and the activation switch 17 are disposed such that they are proximal to the power source 15 at the distal portion of the second end of the shaft 19.

The activation switch 17 is configured to control the operation of the motor 20, such that actuating the activation switch 17 starts the motor 20. In the illustrated embodiment, the activation switch 17 comprises a biased switch, such as a push button switch, wherein holding the push button completes the circuit and actuates the motor. However, in other embodiments, the activation switch 17 comprises a toggle switch or a rocker switch, such that the motor 20 can be toggled on or off.

The control module 16 is configured to control the frequency of the vibrations produced by the motor 20. In the illustrated embodiment, the control module 16 comprises a rheostat configured as a rotary dial. The rheostat of the control module 16 is configured to vary the resistance applied to the motor, wherein turning the control module 16 in one direction increases the frequency of the vibrations, whereas turning the control module 16 in the opposite direction decreases the frequency of the vibrations.

Referring now to FIG. 3, there is shown a perspective view of an embodiment of the power source and charging station. In the illustrated embodiment, the power source 15 comprises a rechargeable battery that is removably secured within the housing of the powered crowbar. In this embodiment, the rechargeable battery 15 is configured to recharge by way of a charging station 18. In the illustrated embodiment, the rechargeable battery 15 comprises a channel configured to pair with a protrusion along the charging station 18 to ensure the rechargeable battery 15 is inserted properly and locked into the charging station 18. The charging station 18 is configured to plug into an outlet on a wall thereby allowing a user to charge the rechargeable battery 15 prior to using the powered crowbar 11. In this way, an individual can use the powered crowbar 11 without being constrained by a charging cord, giving the individual greater movement and flexibility when working.

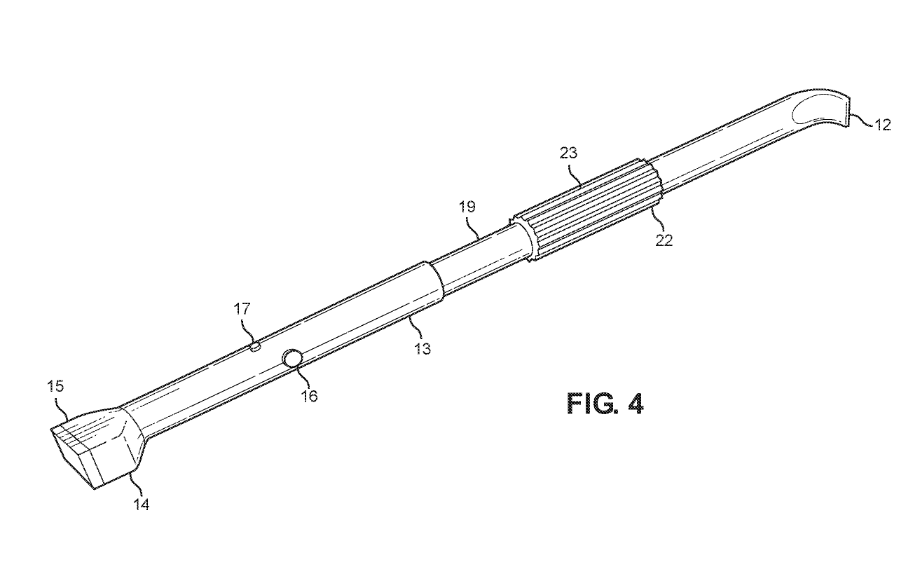

Referring now to FIG. 4, there is shown a perspective view of the powered crowbar with an additional housing. In one embodiment, the motor of the powered crowbar is disposed at the first end of the shaft 19, such that the motor is disposed proximal to the chisel 12, wherein the motor is configured to draw power from the power source disposed at the second end of the shaft 19 through a plurality of wires. In the shown embodiment, the control module 16 and activation switch 17 are disposed along the housing 14 at the second end of the shaft 19, however in other embodiments, the control module 16 and activation switch 17 are disposed proximal to the motor.

In the shown embodiment, an additional housing 22 is disposed at the first end of the shaft 19, wherein the additional housing 22 is configured to house the motor. Further, the additional housing 22 comprises a plurality of cooling fins 23 extending outwardly therefrom. The plurality of cooling fins 23 are configured to aid in cooling the motor, such that the motor does not overheat when positioned in close proximity to the chisel 12. In the shown embodiment, the plurality of cooling fins 23 are disposed at even intervals about the additional housing 22, and the length of each cooling fin 23 is equivalent. However, in other embodiments the plurality of cooling fins 23 are disposed such that a portion of the additional housing 22 has a greater number of cooling fins 23 than a different portion of the additional housing 22. In another embodiment, the plurality of cooling fins 23 are disposed such that each fin varies in height, thereby modifying the air flow dispersed from the motor.

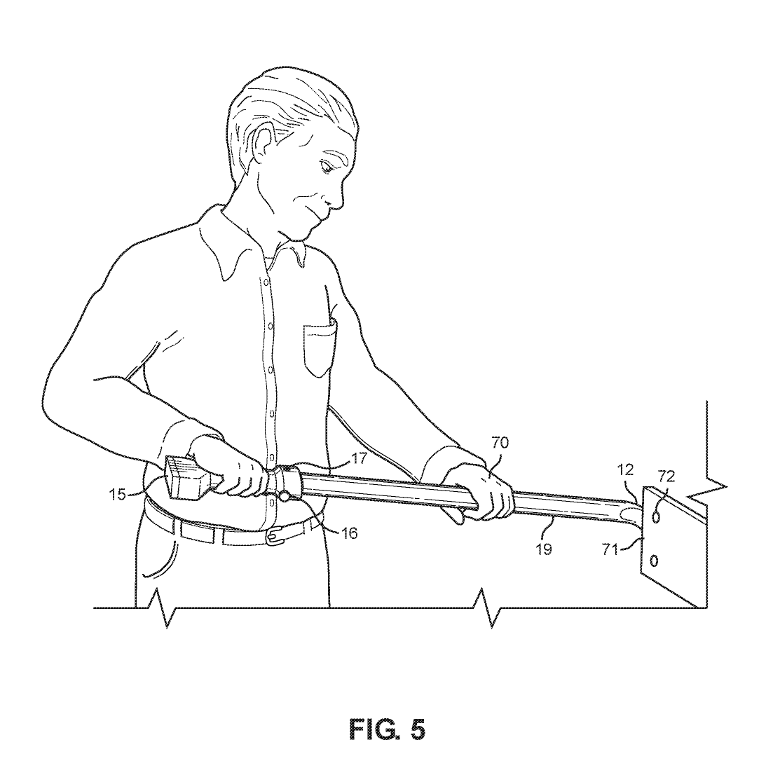

Referring now to FIG. 5, there is shown a perspective view of an embodiment of the powered crowbar in use. In the illustrated embodiment, the powered crowbar is shown in use removing nails 72 from a board 71, however the powered crowbar can be utilized to remove materials secured to surfaces via fasteners other than nails 72. In the shown embodiment, the tapered end of the chisel 12 is configured to fit between the board 71 and the wall, such that the vibrations produced by the motor are configured to loosen the nails 72 from the board 71, thereby aiding in removing the board 71 from the surface. In the illustrated embodiment, the grip is sized for a male's hand 70, however in other embodiments the grip is sized for a smaller hand, such as a female's hand, and as such the size of the grip can vary appropriately.

In operation, a user ensures the powered crowbar is at full power, such that the rechargeable battery is fully charged and can provide the requisite energy to the motor, allowing it to operate optimally. The user, finding a wooden board that needs to be removed, inserts the chisel between a board and the surface it is secured to, such as a wall or a crate. The user can then press or toggle the activation switch, thereby actuating the motor of the powered crowbar. The high frequency vibration from the powered crowbar causes the board to loosen, and in this way when the user attempts to pry the board off the crate, less overall force is required. Thereby, the user can easily and successfully remove the wooden board from the wall or the crate.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A powered crowbar, comprising:
a shaft having a first end and a second end;
wherein the first end tapers to a flat chisel, such that the chisel is configured to fit within tight spaces;
wherein the second end comprises a housing and a grip, wherein the grip is configured to be held by a user;
the housing having a motor, a power source operably connected to the motor, a control module operably connected to the motor, and an activation switch operably connected to the motor;
an unbalanced rotating shaft disposed at the first end of the shaft and operably connected to the motor;
wherein the motor is configured to vibrate the unbalanced rotating shaft and chisel.

2) The powered crowbar of claim 1, wherein the power source is disposed on the distal end of the second end of the shaft, and the grip is disposed proximal to the power source.

3) The powered crowbar of claim 1, wherein the grip is composed of a non-conductive vibration absorbent material.

4) The powered crowbar of claim 3, wherein the grip comprises a length such that two hands can be placed thereon.

5) The powered crowbar of claim 1, wherein the housing tapers inwardly from opposing ends thereof to form the grip.

6) The powered crowbar of claim 1, wherein the power source comprises a rechargeable battery removably secured within the handle.

7) The powered crowbar of claim 1, wherein the control module comprises a rheostat configured to alter the frequency of the vibrations generated by the motor when actuated.

8) The powered crowbar of claim 1, wherein the housing further comprises a strain gauge operably connected to the motor configured to enable automatic motor output.

9) The powered crowbar of claim 1, wherein the shaft comprises a flexible inner shaft.

10) A powered crowbar, comprising:
a shaft having a first end and a second end;
wherein the first end tapers to a flat chisel, such that the chisel is configured to fit within tight spaces;
a motor disposed at the first end;
wherein the second end comprises a housing and a grip;
the housing having a power source operably connected to the motor, a control module operably connected to the power source, and an activation switch operably connected to the power source.

11) The powered crowbar of claim 10, wherein the first end comprises an additional housing for the motor, wherein the additional housing has a plurality of cooling fins extending therefrom.
